(19) United States
(12) Patent Application Publication
(10) Pub. No.: US 2012/0192003 A1
(43) Pub. Date: Jul. 26, 2012

(54) COMPUTER STATUS MONITORING DEVICE, COMPUTER MONITORING SYSTEM AND COMPUTER STATUS MONITORING METHOD

(75) Inventors: Kenichi Akiyama, Yokohama (JP); Keisuke Hatasaki, Kawasaki (JP); Yoshifumi Takamoto, Kokubunji (JP); Masayoshi Kitamura, Ayase (JP)

(73) Assignee: Hitachi, Ltd., Tokyo (JP)

(21) Appl. No.: 13/388,569

(22) PCT Filed: Aug. 19, 2010
(86) PCT No.: PCT/JP2010/064017

§ 371 Date: Apr. 16, 2012

(30) Foreign Application Priority Data
Mar. 2, 2010 (JP) 2010-045066

(51) Int. Cl. G06F 11/30; G06F 1/26

(52) U.S. Cl. 713/340

(57) ABSTRACT

In order to monitor the status of a computer by monitoring the power consumption of the computer, a monitoring server (300) is equipped with: a power status database (400) in which power consumption patterns for each status of a computer (500) are stored; and a computer status detection unit (220) that determines which pattern stored in the power status database resembles the transition pattern of the measurement data obtained by the data acquisition unit (205), and then detects the status corresponding to the pattern which is deemed to be similar to the status of the computer being monitored.

### TECHNICAL FIELD

The present invention relates to a computer status monitoring device, a computer monitoring system, and a computer status monitoring method which can monitor status of a computer by monitoring power consumption of the computer.

### BACKGROUND ART

As a computer status monitoring method, a means of executing software such as agent programs or the like to monitor faults or performances, on the computer which is a management object, is common. Monitoring by the agent programs is capable of acquiring detailed information for managing the status, since the monitoring is operated on the managed object. However, there are problems such as agent programs required to be installed in advance for the management and more time-consuming works for the system construction.

On the other hand, it has been attempted to utilize change patterns of power consumption to detect status of the apparatuses. Patent document 1 discloses a method performed utilizing the power consumption, when monitoring home appliances. For example, electric power of a microwave-oven at a time when heating is measured in advance, a comparison is made with electric power patterns registered in advance in the case that a great variation of power consumption is found, and a home appliance which has matched the pattern and how the status of the home appliance is are indicated. By utilizing power consumption, it is possible to monitor apparatuses to which software such as agent programs or the like cannot be installed.

### PRIOR ART REFERENCES

### Patent Documents

PATENT DOCUMENT 1: JP 2002-340945 A

### SUMMARY OF THE INVENTION

### Problems to be Solved by the Invention

In conventional methods utilizing agent programs or the like, monitoring programs on the computer need to have been executed, and in these methods, the computer status could not be detected, immediately after a boot-up of the computer when the monitoring program cannot be operated, or during a dump acquisition upon a malfunction termination.

Furthermore, in the method of patent document 1, detecting power consumption patterns of home appliances is described. Many home appliance products are apparatuses comprise a single function, for example in the case of heating by a microwave-oven, the power consumption amount necessary when heating is almost fixed, and the status can be detected by detecting relatively simple patterns such as upper limit value, lower limit value or the like.

However, computers have a great number of component parts and the power consumption greatly varies depending on programs to be executed like processors, the magnitude of loads such as multiplicity or the like. Therefore, it is difficult to detect the status by monitoring simple upper limit value, lower limit value or the like from power supply ON to power supply OFF. Moreover, in the case to manage a great number of computers, it is difficult to have measured the power consumption for all apparatuses in advance, since the power consumption per each computer is different. In addition, a method to make a correspondence between the power consumption and the computer status for the computer as an object is not shown.

The present invention is made to solve the aforementioned problem and an object of the present invention is to provide a computer status monitoring device, a computer monitoring system, and a computer status monitoring method which can monitor the computer status by monitoring the power consumption of the computer.

### Means of Solution of the Problem

In order to achieve the aforementioned purpose, the computer status monitoring device of the present invention is a computer status monitoring device (for example, monitoring server 300) for monitoring the computer status utilizing the measurement data of the power consumption measuring device to measure the power consumption of the computer to be a monitored object and comprises a power status database in which patterns of power consumption per status of the computer are stored; a data acquisition unit for acquiring measurement data of the power consumption measured by the power consumption measuring device; and a computer status detection unit for judging which status pattern stored in the power status database a change pattern of the acquired measurement data is similar to or not and detecting a status corresponding to the pattern which has been judged to be similar as a computer status of the monitored object.

Descriptions will be made later regarding a computer status data generating unit for generating the change data of the power consumption to indicate the computer status, a computer status monitoring unit for detecting malfunction of the computer status detected from the power consumption, and a operation status detection unit for detecting the operation status of the processor utilizing the change patterns of the power consumption specific to the computer, those of which the computer status monitoring device of the present invention comprises.

### Effect of the Invention

According to the present invention, it is possible to monitor the status of the computer by monitoring the power consumption of the computer.

### BRIEF DESCRIPTION OF THE DRAWINGS

FIG. 1 is an entire structure diagram showing a computer monitoring system of the present invention;

FIG. 2 is an explanatory drawing showing an example of the actual measurement data of the power consumption of the computer;

FIG. 3 is an explanatory drawing showing an example of the waveform pattern table of the power status database;

FIG. 4 is a conceptual drawing showing the waveform pattern data of the power status database;

FIG. 5 is an explanatory drawing showing an example of the waveform range table of the power status database;

FIG. 6 is a conceptual drawing showing an example of the waveform range data of the power status database;

FIG. 7 is an explanatory drawing showing an example of the status transition table of the power status database;

FIG. 8 is a conceptual drawing showing the status transition data of the power status database;

FIG. 9 is a flowchart showing the computer operation during the change pattern acquisition;

FIG. 10 is a flowchart showing the processing of the computer status data generating unit;

FIG. 11 is a flowchart showing the processing of the computer status detection unit;

FIG. 12 is a flowchart showing the processing of the computer status monitoring unit; and

FIG. 13 is a flowchart showing the processing of the operation status detection unit.

### MODES FOR CARRYING OUT THE INVENTION

Below, explanations are made regarding an embodiment of the present invention in detail with reference to the drawings.

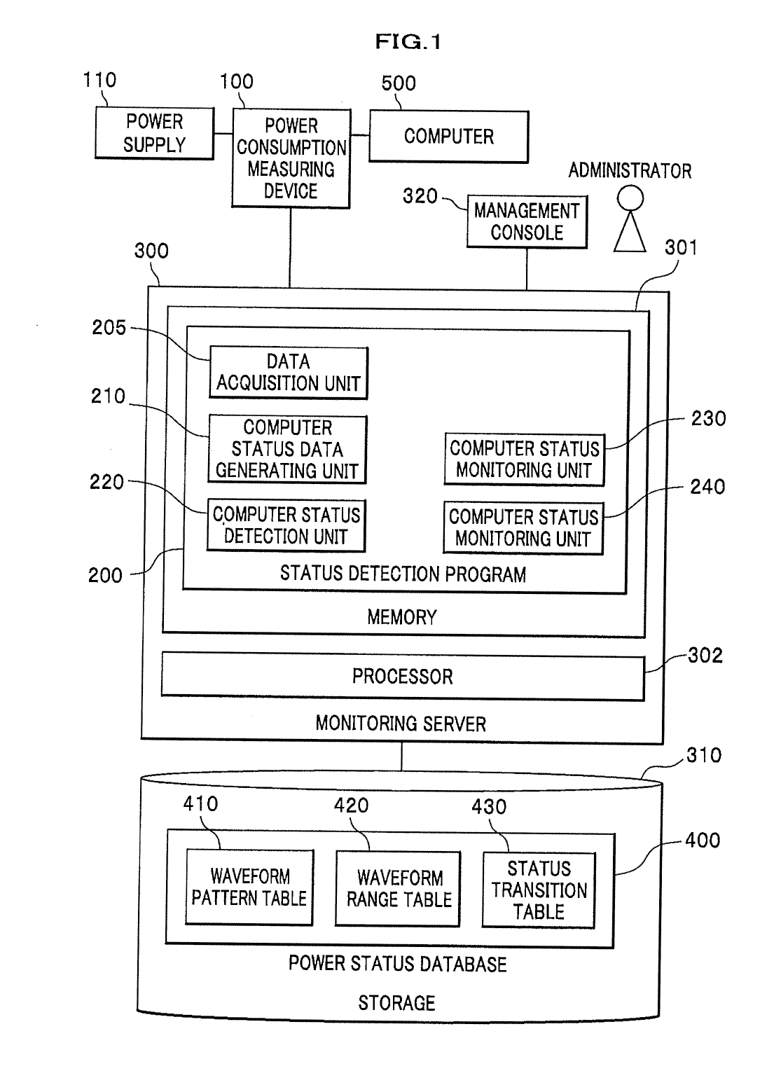

FIG. 1 is an entire structure diagram showing a computer monitoring system of the present invention. The computer monitoring system comprises a power consumption measuring device 100, a monitoring server 300 (status monitoring device of computer), a storage 310, and a management console 320.

The power consumption measuring device 100 is an apparatus arranged between a computer 500 and a power supply 110 for measuring the power consumption of the computer 500. Though the power consumption measuring device 100 described in this embodiment is independent of the computer 500, it may be stored in the interior of the computer 500. Moreover, in the case that a plurality of computers 500 are stored in a single chassis like blade-type computers, the power consumption measuring device 100 may be provided for each of the blades or provided for each chassis.

The monitoring server 300 receives the power consumption of the computer 500 of a monitored object from the power consumption measuring device 100, detects the status of the computer 500, and comprises a function for notifying a management console 320. The storage 310 stores a power status database 400 in which a correspondence between the computer status and the change pattern of the power consumption is made. The management console 320 is a console which an administrator utilizes for confirming the status of the computer 500.

The monitoring server 300 comprises a memory 301, a processor 302, a network interface (not shown), a disk interface (not shown) of the storage 310 and the like. In the interior of the memory 301, a status detection program 200 is stored. The processor 302 executes various programs such as the status detection program 200 stored in the memory 301 or the like, thereby each processing of a computer status data generation processing, a computer status detection processing, a computer status monitoring processing, an operation status detection processing, and a receiving processing from a power consumption measurement processing is performed.

A status detection program 200 is a program for comparing the power consumption received from the power consumption measuring device 100 via the network interface and a table stored in the power status database 400, and detecting the status of the computer 500.

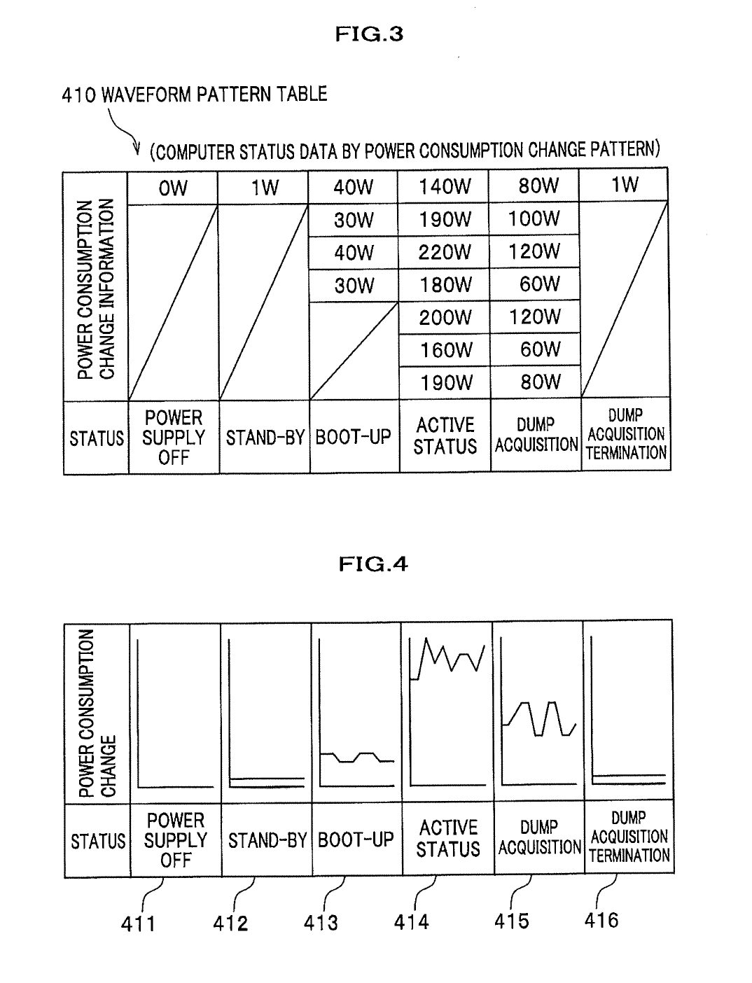

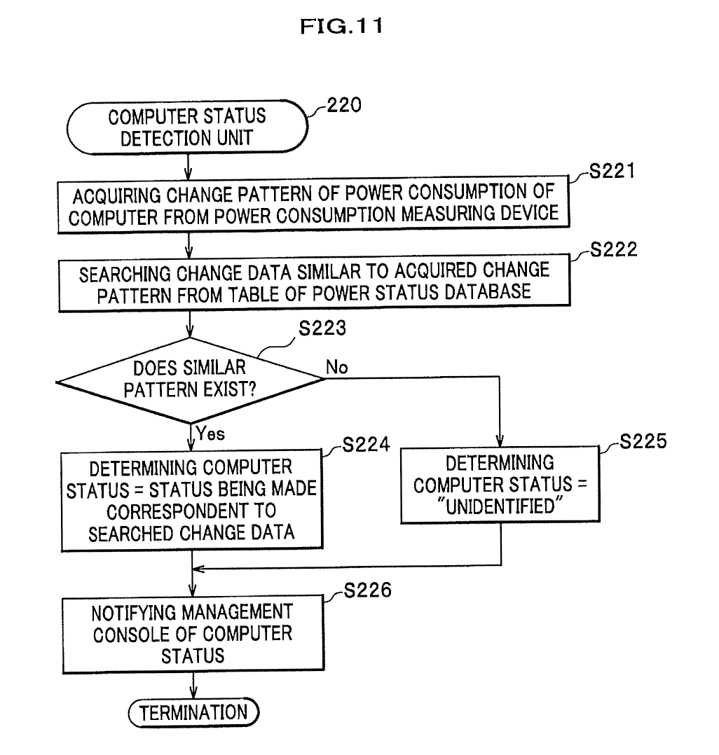

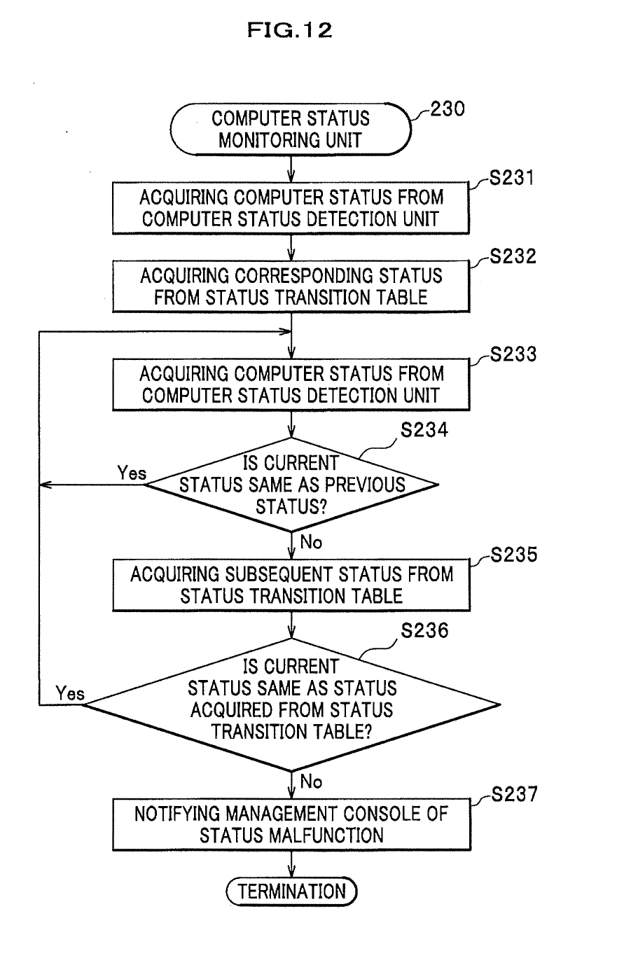

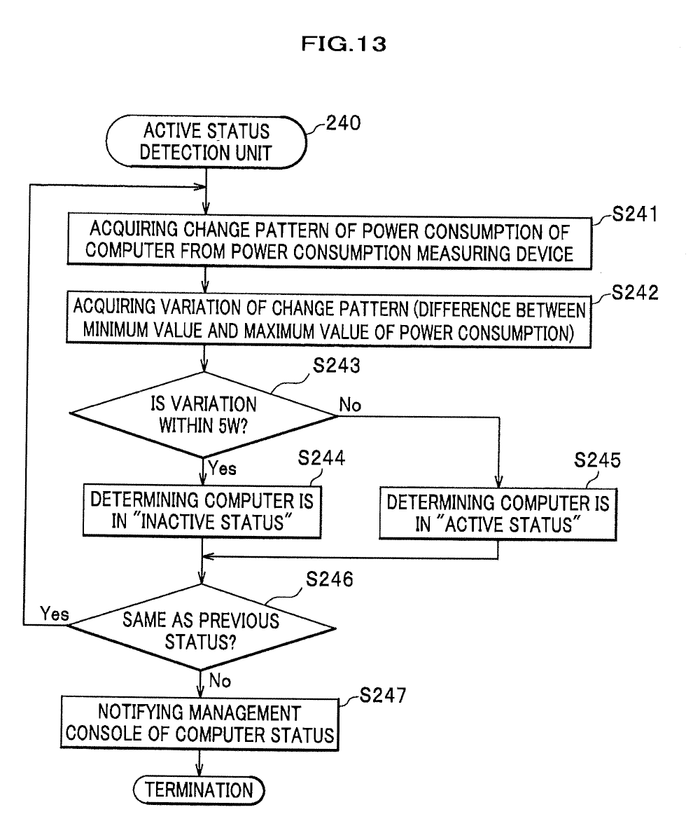

The status detection program 200 comprises 5 modules of a data acquisition unit 205 for acquiring the measurement data of the power consumption measured by the power consumption measuring device 100, a computer status data generating unit 210 (see FIG. 10) for storing the computer status and the change data of the power consumption (for example, the power consumption change information in FIG. 3) being made correspondent in the power status database 400, a computer status detection unit 220 (see FIG. 11) for detecting the status of the computer, a computer status monitoring unit 230 (see FIG. 12) for monitoring the normal status/malfunction status of the computer, and a operation status detection unit 240 (see FIG. 13) for detecting whether the operating system in the computer is active or inactive.

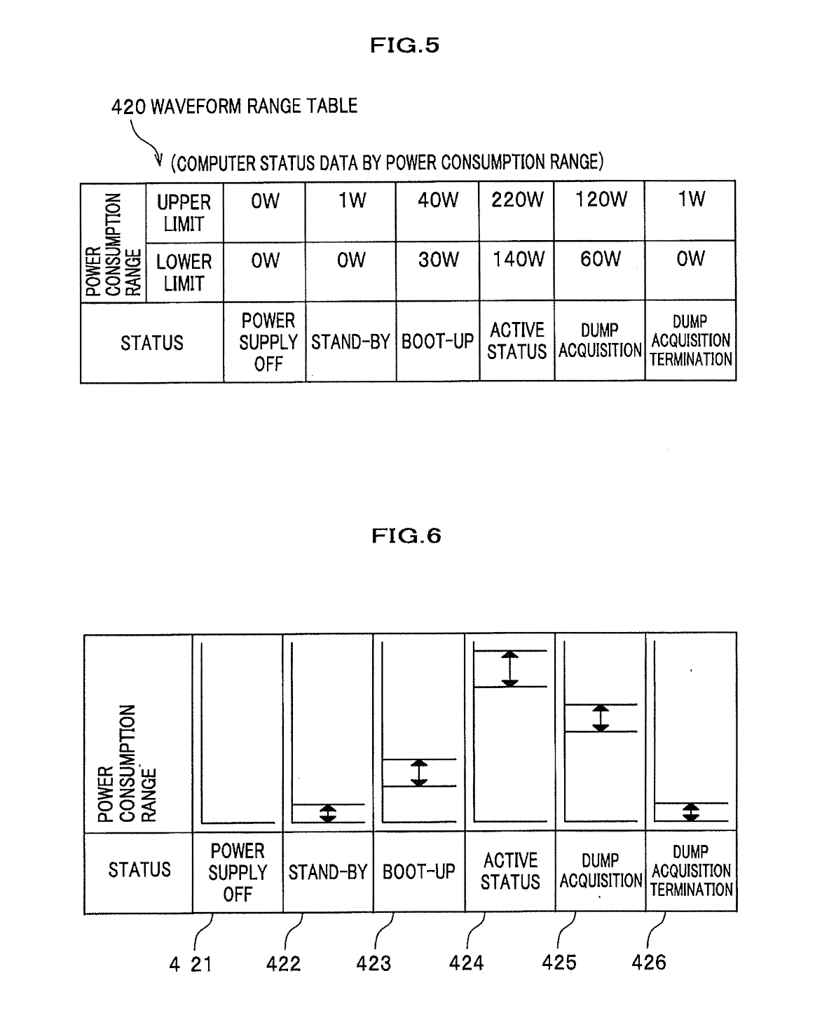

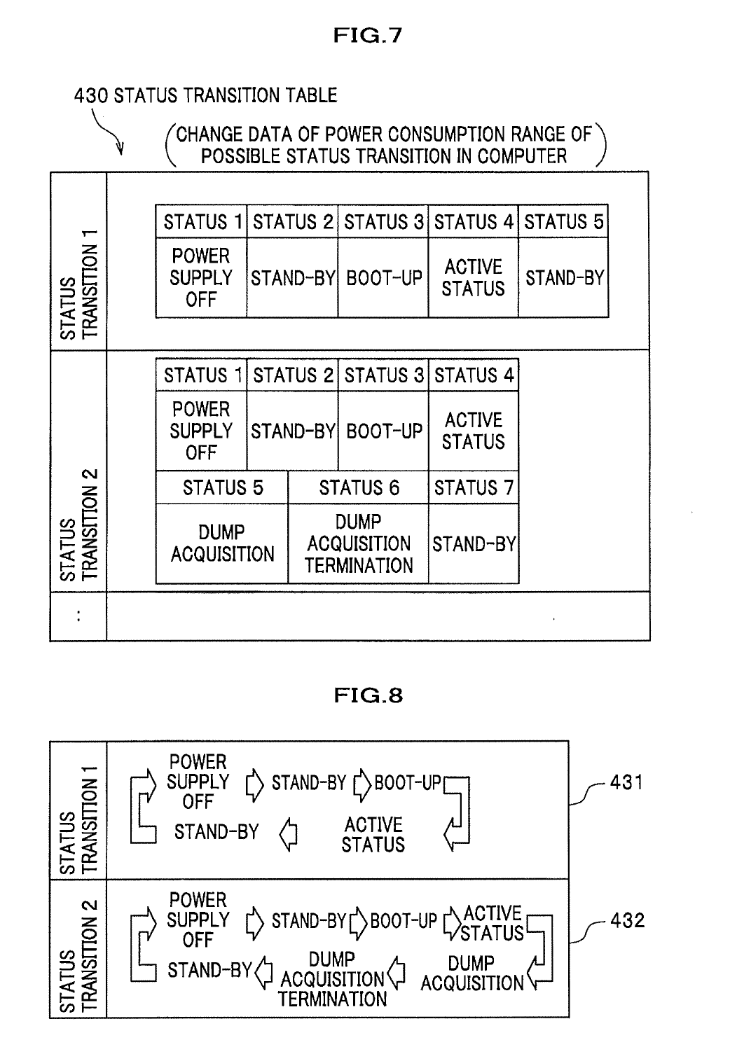

The power status database 400 is a database for storing a table which indicates a combination of the power consumption of the computer and the status of the computer, and comprises tables such as a waveform pattern table 410 (see FIG. 3) to systemize the power consumption change pattern of the computer and the status of the computer, a waveform range table 420 (waveform range information) (see FIG. 5) to systemize the power consumption range of the computer and the status of the computer, and a status transition table 430 (status transition information) (see FIG. 7) to store the status transition in the case that the computer normally operates. Incidentally, in this embodiment, the power status database 400 is stored in the storage 310 which is an external storage, however it is not limited to this. The power status database 400 may be stored in the internal storage of the monitoring server 300.

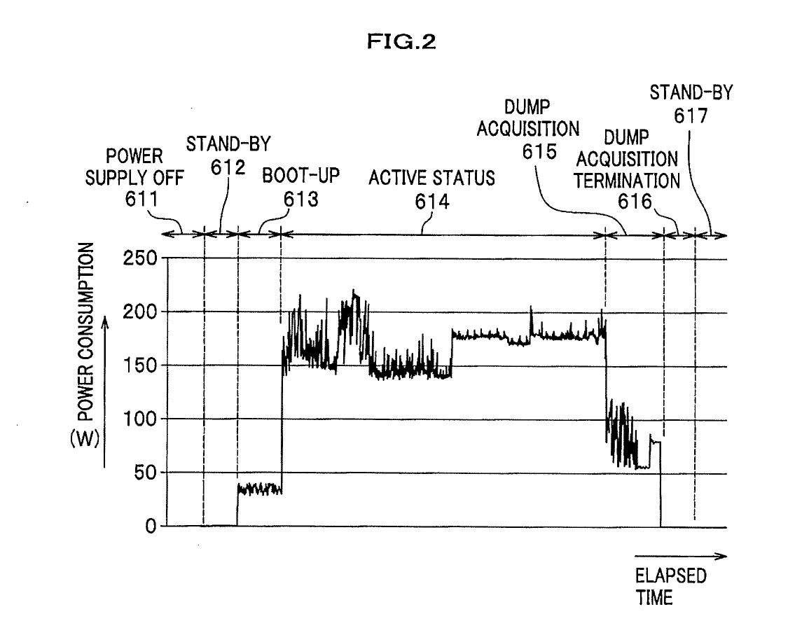

FIG. 2 is an explanatory drawing showing an example of the actual measurement data of the power consumption of the computer. FIG. 2 shows a variation (vertical axis) of the power consumption from the boot-up of the computer to the dump acquisition and stand-by being made, graphed on the elapsed time (horizontal axis). The power consumption of the computer 500 is an electric power value which components of the computer 500 consume. As shown in the FIG. 1, in general, the computer 500 comprises a processor, a memory, a power supply apparatus, a fan, an adaptor to connect the computer 500 and external apparatuses and the like, which are not shown in drawings. The power consumption value varies also depending on the number of the processors, the capacity of the built-in memories, or the number of the adaptors. However, in general, the number of the processors and the capacity of the memories don't vary dynamically during the active status of the computer 500.

What shows a great variation during the active status is the processor. The processor has a very many built-in logical circuits on the semiconductor, and an electric power is consumed for operating logical circuits, thereby, the power consumption value as a whole processor becomes larger. On the other hand, a technique to reduce the power consumption of the processor has been developed, and it is possible to make arrangements so that the logical circuits of the processor which is not being utilized don't consume the electric power. Therefore, the processor which is not in the status of executing a command consumes a small amount of the power. However, when the utility ratio of the processor is getting higher due to the higher load, most of the logical circuits in the processor are getting in the active status, thus the power consumption becomes larger. In this way, of the power consumption of the computer 500, the static power consumption varies depending on the built-in components, however the primary element with which the power consumption dynamically varies during the active status of the computer 500 is an operation ratio of the processor.

In other words, it is possible to express that the power consumption of the computer 500 is a sum of an electric power (constant electric power) which the components constantly consume regardless of the load and an electric power (variable electric power) which dynamically varies depending on the load magnitude like a processor. That is to say, the constant electric power means (a maximum value of) an electric power which constantly changes utilizing little of the electric power in power supply OFF (power supply OFF) (611), stand-by 612, dump acquisition termination 616, and stand-by 617, and the variable electric power means an electric power to deduct the “constant electric power” from the electric power at the time the change of the power consumption is sharp while the processor is operating, from the boot-up 613 to the dump acquisition 615 (if the dump acquisition is not performed, from the boot-up 613 to the active status 614).

For example, in FIG. 2, the power consumption for the status of power supply OFF (611) is 0 watt (W), however it is 1 W for the stand-by 612, thereafter, it is 40 W in the boot-up 613 since a part of components of the computer 500 are powered on, and in and after the active status 614, all components of the computer 500 are powered on and the electric power value varies depending on the operation ratio of the processor. It is possible to describe that the variation of the electric power value in and after the boot-up 613 expresses the load status of the processor, because the variation is an aforementioned variable electric power and varies depending on the operation ratio of the processor,

Incidentally, the stand-by in FIG. 2 signifies the status in which processors or the like are not working, and is different from the mode in which the electric power continues to be supplied to the memories storing the system and the processing status of the application on Windows (registered trademark) and is off for the other devices.

FIG. 3 is an example of the waveform pattern table 410 stored in the power status database 400 (see FIG. 1). In the waveform pattern table 410, each status (power supply OFF, stand-by, boot-up, active status, dump acquisition, dump acquisition termination) and the power consumption change information to be the characteristic for each status are shown. In particular, OW in the status of the power supply OFF, 1 W in the stand-by, and a vibrating waveform such as 40 W, 30 W, 40 W, and 30 W in the boot-up. In the active status, the power consumption is higher than that in the boot-up, and the vibration amplitude is relatively high, being 140 W, 190 W, 220 W, 180 W, 200 W, 160 W, and 190 W. In addition, in the dump acquisition, the power consumption is generally less than that in the active status, being 80 W, 100 W, 120 W, 60 W, 120 W, 60 W, and 80 W. Moreover, it is 1 W in the dump acquisition termination.

In the generation of the waveform pattern table 410, in particular, the average values per predetermined time and the measurement value measured in the predetermined interval time are used. Here, an explanation is made for the former average values per predetermined time as an example. In order to generate the waveform pattern table 410, the measurement time for each status is specified.

That is to say, the measurement time for each status is specified, and the measurement is made not without interruption from the power supply OFF to the dump acquisition termination, but in the measurement time in which the characteristic phenomenon can be grasped in each status. In this measurement time, if the same time length is specified for the measurement time of the active status and the measurement time of dump acquisition, the “predetermined time” is the same for both.

In the case of the waveform pattern table 410 shown in FIG. 3, in the stand-by, 1 W which is a characteristic value indicating that the value changes little is shown, and in the active status and the dump acquisition, 7 values with which the characteristic for each status appears are shown.

The content of the power status database 400 (see FIG. 1) including the waveform pattern table 410 may be acquired in the active status of the computer 500 or may be acquired in advance before the computer 500 starts the operation. For example, the administrator of the computer 500 starts the measurement of the power consumption taking the event of the power supply ON (power supply ON), stops the measurement of the power consumption taking the event when the boot-up of the operating system of the computer 500 is complete, and acquires the measurement result of the power consumption from the power consumption measuring device 100, thereby the pattern of the boot-up can be acquired.

The point here is acquiring of the patterns with which the characteristic for the status of the computer 500 appears. The acquisition methods such as making the interval to measure the power consumption short in the case that a sharp pattern of the variation of the power consumption is measured, making the interval to measure the power consumption long in the case that the infrequent variation of the power consumption occurs or the like are thinkable. That is to say, by storing the time when the power consumption varies and the variation amount, the power status database 400 can increase the patterns which are capable to correspond.

As aforementioned, the power consumption includes the electric power (constant electric power) which components constantly consume regardless of the load, and the electric power (variable electric power) which dynamically varies depending on the magnitude of the load like processors. In the power status database 400, the measurement result (constant electric power+variable electric power) of the power consumption of the computer 500 may be stored, or only the variable electric power indicating the status of the load of processors may be stored. The value of the constant electric power is an electric power in the status in which the computer 500 is booted up and the load of the processor doesn't exist, and can be acquired by measuring this electric power with the power consumption measuring device 100. In order to extract only the variable electric power, the acquisition can be made by subtracting the constant electric power value from the electric power value acquired by the power consumption measuring device 100. By registering only the variable electric power in the power status database 400, the correspondence range of the computer 500 can be broadened. That is to say, even for the aforementioned computers 500 with different constant electric powers, for example, computers with different memory capacities or a different number of the processors, the status can be detected, therefore it becomes possible to perform the management to correspond to a variety of models.

FIG. 4 is a conceptual drawing of the waveform pattern data of the power status database 400. 411 indicates the power supply OFF status, 412 indicates the stand-by status, 413 indicates the boot-up status, 414 indicates the active status, 415 indicates the dump acquisition status, and 416 indicates a figure to conceptualize the dump acquisition termination status. In each of the power consumption change diagrams, the horizontal axis indicates the time and the vertical axis indicates the power consumption. In this way, by having registered the variation which is of a characteristic of the power consumption in each status, the status of the computer 500 can be estimated by detecting the variation of the power consumption.

FIG. 5 is an example of the waveform range table

420 stored in the power status database 400. The waveform range table 420 is a table more simplified than the power consumption change information (see FIG. 4) of the status of the computer 500. The status of the computer 500 is shown with the upper limit and the lower limit of the power consumption. With this table, the approximate status of the computer 500 can be detected easily. For example, it becomes possible to detect which of the power supply OFF status, the stand-by status, or the boot-up/active status the current status is, by viewing the range of the power consumption.

FIG. 6 is a conceptual drawing of the waveform range data of the power status database. 421 indicates the power supply OFF status, 422 indicates the stand-by status, 423 indicates the boot-up status, 424 indicates the active status, 425 indicates the dump acquisition status, and 426 indicates a figure to conceptualize the dump acquisition termination status.

FIG. 7 is an example of the status transition table 430 stored in the power status database 400. The status transition table 430 is a table to detect the status of the computer 500 more easily. In the case of the transition from a certain status to the other status, it becomes possible to easily acquire the candidate of the other status. For example, the possible status to occur subsequently to the status of the power supply OFF is the stand-by only, and the dump acquisition status subsequent to the power supply OFF doesn't occur. In this way, the accuracy of the status of the computer 500 according to the present invention can be made higher by having registering in advance the candidate of the transition.

FIG. 8 is a conceptual drawing of the status transition data of the power status database 400. 431 and 432 are the status variations shown by the status transition data of the computer exemplified in the status transition table 430. That is to say, in the case of the status transition 1 of 431, the transitioning from the power supply OFF status, the stand-by status, the boot-up status, the active status, the stand-by status, and power supply OFF status is shown. And in the case of the status transition 2 of 432, the transitioning from the power supply OFF status, the stand-by status, the boot-up status, the active status, the dump acquisition status, the dump acquisition termination status, stand-by status, and the power supply OFF status is shown.

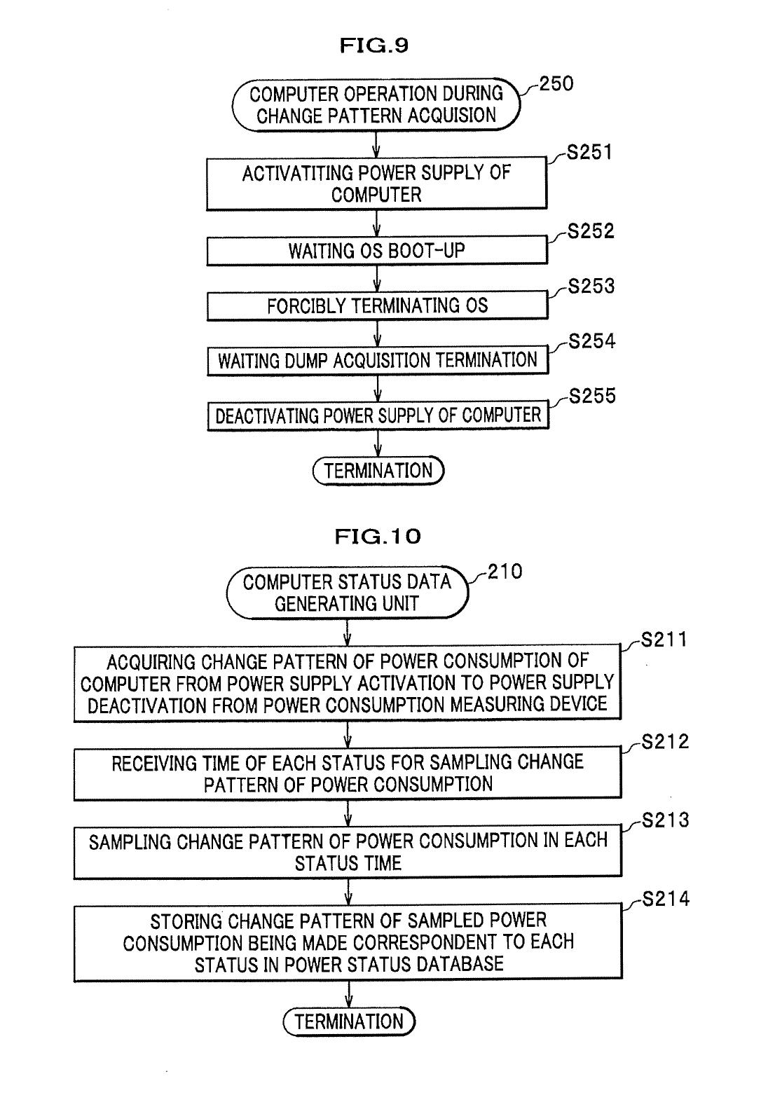

Subsequently, the processing of each unit will be explained. FIG. 9 through FIG. 13 are figures to exemplify the flows in the each unit in the status detection program 200 (see FIG. 1). An explanation is made regarding these figures in the following example.

### A TABLE GENERATION EXAMPLE 1 OF POWER STATUS DATABASE

With reference to FIG. 9 and FIG. 10, an example of the procedure to make a correspondence between the change pattern of the power consumption and the status for the computer and to store them in the power status database is shown. First, the operation of the computer when making a correspondence between the change pattern of the power consumption and the status for the computer is explained in FIG. 9.

FIG. 9 is a flowchart showing the computer operation 250 during the change pattern acquisition. First, the administrator of the computer 500 activates the power supply of the computer (Step S251) and waits the boot-up of the operating system (OS) (Step S252). The administrator forcibly terminates the OS after confirming the operating system has been booted up (Step S253). Then, the administrator waits the dump acquisition termination (Step S254), and deactivates the power supply when the dump acquisition is terminated (Step S255).

Incidentally, in FIG. 9, the explanation has been made as the operation of the administrator, however, as the monitoring server 300 comprises a program to remote-log-in the computer 500 and to perform a processing in FIG. 9, the operation 250 of the computer in the change pattern acquisition may be automatically executed by the administrator's designation via the management console 320.

FIG. 10 is a flowchart showing the processing of the computer status data generating unit 210. With reference to FIG. 10, an explanation is made regarding the processing of the computer status data generating unit 210 at the time when the computer status is made corresponding to the change pattern of the power consumption acquired via the data acquisition unit 205 and stored in the power status database.

As a result of the operation of the computer in FIG. 9, the power consumption measuring device 100 outputs the change pattern of the power consumption of the computer shown in FIG. 2. The computer status data generating unit 210 acquires the change patterns of the power consumption of the computer from the power supply activation to the power supply deactivation, from the power consumption measuring device 100 via the data acquisition unit 205 (Step S211), and receives the setting time of the each status (power supply OFF, stand-by, boot-up, active status, dump acquisition, dump acquisition termination) for sampling the change patterns of the power consumption based on the input from the management console 320, from the management console 320 (Step S212).

The computer status data generating unit 210 samples the change pattern of the power consumption in the time for each status (Step S213), makes the sampled change pattern of the power consumption correspondent to each status, and stores the result in the power status database (Step S214).

As aforementioned, the power consumption includes the electric power (constant electric power) which components constantly consume regardless of the load, and the electric power (variable electric power) which dynamically varies depending on the magnitude of the load like processors. In the power status database 400, the measurement result (constant electric power+variable electric power) of the power consumption of the computer 500 may be stored or only the variable electric power indicating the status of the load of processors may be stored. The value of the constant electric power is an electric power in the status at the time when the computer 500 is booted up and the load of the processor doesn't exist, and can be acquired by measuring this electric power with the power consumption measuring device 100. In order to extract only the variable electric power, the acquisition can be made by subtracting the constant electric power value from the electric power value acquired by the power consumption measuring device 100. By registering only the variable electric power in the power status database, the correspondence range of the computer 500 can be broadened. That is to say, even for the aforementioned computers 500 with different constant electric powers, for example, computers with different memory capacities or a different number of the processors, the status can be detected, therefore it becomes possible to perform the management to correspond to a variety of models.

The computer status data generating unit 210 of the monitoring server 300 of this embodiment can acquire the measurement data from the activation of the power supply of the computer 500 to the deactivation of the power supply of the computer 500 from the data acquisition unit 205 (Step S211), receive the setting time of the status of the computer 500 for storing the patterns of the power consumption per status (Step S212), sample the measurement data based on the setting time (Step S213), make the sampled measurement data correspondent to the status of the computer 500 and store it in the power status database 400 (Step S214).

### A DETECTION EXMPLE 1 OF COMPUTER STATUS

FIG. 11 is a flowchart showing the processing of the computer status detection unit 220. With reference to FIG. 11, an example of the procedure to detect the status of the computer 500 from the data stored in the power status database generated in the aforementioned method, is shown.

The computer status detection unit 220 acquires change patterns of the power consumption of the computer 500 within a certain time from the power consumption measuring device 100 via the data acquisition unit 205 (Step S221) and searches the change data (power consumption change information shown in FIG. 3) which is similar to the acquired change patterns, from the power status database (Step S222). Then, the computer status detection unit 220 judges whether the similar pattern exists or not (Step S223). In the case that the similar change data could be searched (Step S223, Yes), the computer status detection unit 220 determines that the status being made correspondent is the status of the computer 500 (Step S224) and proceeds to Step S226. In the case that the similar change data is not registered in the power status database (Step S223, No), the computer status detection unit 220 determines that the status of the computer 500 is “unidentified” (Step S225), and proceeds to Step S226. Thereafter, the computer status detection unit 220 notifies the management console 320 of the determined status of the computer 500 (Step S226) and terminates the processing.

Explaining a concrete example, in the Step S223, the status is judged by pattern-matching the change pattern of the power consumption of the computer 500 and the power consumption change information (change data), therefore if it is not only the power consumption at a certain time, but, for example, a change pattern such as 135 W→195 W→210 W→190 W→200 W→155 W→195 W is measured, it is similar to the power consumption change information of the active status in FIG. 3, accordingly the “active status” may be determined in the Step S224.

The monitoring server 300 (computer status monitoring device) of this embodiment is a computer status monitoring device for monitoring the status of the computer 500 utilizing the measurement data of the power consumption measuring device 100 for measuring the power consumption of the computer 500 to be a monitored object. The computer status monitoring device comprises a power status database 400 for storing the patterns of the power consumption per status of the computer 500, a data acquisition unit 205 for acquiring the measurement data of the power consumption measured by the power consumption measuring device 100, and a computer status detection unit 220 for judging which status pattern stored in the power status database 400 the change pattern of the acquired measurement data is similar to (Step S223) and detecting the status corresponding to the pattern which is judged to be similar as the status of the computer to of the monitored object (Step S224).

### A TABLE GENERATION EXAMPLE 2 OF POWER STATUS DATABASE

In FIG. 10, the computer status data generating unit 210 receives the change patterns of the power consumption from the power consumption measuring device 100 and the time for each status of the computer 500 from the management console 320, thereafter, the minimum value and the maximum value of the power consumption within the time for each status are acquired. These minimum value and maximum value are set as the lower limit value and the upper limit value of the power consumption in the status of the computer 500, and stored in the power status database as a waveform range table 420 (see FIG. 5) being made correspondent with the status of the computer 500.

### A DETECTION EXAMPLE 2 OF COMPUTER STATUS

In FIG. 11, the computer status detection unit 220 acquires the electric power range (minimum value/maximum value) of the change pattern of the power consumption of the computer 500 within a certain time, received from the power consumption measuring device 100. A combination of the lower limit value/upper limit value of the power consumption including this electric power range is searched from the waveform range table 420 of the power status database 400. In the case that the included range could be searched, the status being made correspondent is determined to be the status of the computer 500. In the case that the included range is not registered in the power status database 400, the status of the computer 500 is set “unidentified”. Thereafter, the management console 320 is notified of the determined status of the computer 500.

Incidentally, the above describes that, in the case that the included range could be searched, the status being made correspondent is determined to be the status of the computer 500, however a limitation is not made to this. When the minimum value and the maximum value of the power consumption are acquired from the change pattern of the measurement data and the pattern is similar to the waveform range table 420 (waveform range information) of the power consumption of the change data in the power status database 400, this may be determined to be the status of the computer 500.

The monitoring server 300 (computer status monitoring device) of this embodiment stores a waveform range table 420 (waveform range information) to make the patterns of the power consumption for each status of the computer 500 correspondent to the lower limit value and the upper limit value of the power consumption of the computer 500 in the power status database 400, and the computer status detection unit 220 can acquire the minimum value and the maximum value of the power consumption from the change pattern of the acquired measurement data, judge which status pattern stored in the power status database 400 the change pattern of the acquired measurement data is similar to based on the waveform range information of the power consumption, and detect the status corresponding to the pattern which has been judged to be similar as the status of the computer of the monitored object.

### A MALFUNCTION STATUS DETECTION EXAMPLE OF COMPUTER

FIG. 12 is a flowchart showing the processing of the computer status monitoring unit 230. With reference to FIG. 12, the method to detect a status malfunction of a computer is shown. The computer status monitoring unit 230 acquires the status of the computer 500 from the computer status detection unit 220 (Step S231), and acquires the corresponding status from the status transition table 430 (Step S232).

Further, the computer status monitoring unit 230 periodically acquires the status of the computer 500 from the computer status detection unit 220 (Step S233), judges whether the current status is the same as the previous status or not (Step S234), and proceeds back to the Step S233 in the case that it is the same (Step S234, Yes). In the case that the current status is not the same as the previous status (Step S234, No), the computer status monitoring unit 230 acquires the subsequent status from the status transition table 430 (Step S235), judges whether the current status is the same as the status acquired from the status transition table 430 or not (Step S236), and proceeds back to the Step S233 in the case that it is the same (Step S236, Yes). That is to say, a comparison is made with the status transition table 430 of the power status database 400 and the aforementioned processing is repeated if the case of the normal transition.

In the case that the status varies (Step S236, No), the computer status monitoring unit 230 determines that the computer has transitioned to the status malfunction (malfunction status), notifies the management console of the status malfunction (Step S237), and terminates the processing.

Incidentally, in the Step S235, in the case of a plurality of the same status existing, all of “subsequent status” may be acquired. And in the case of a plurality of the same status existing in the Step S236, a comparison may be made for whether any of those matches.

The content of the processing in FIG. 12 is further explained concretely.

In the Step S231, for example, the “boot-up” is acquired.

In the Step S232, the “status 3” which is a corresponding status is acquired from the status transition table 430.

In the Step S233, for example, if the “active status” is acquired, No is for the Step S234 and the proceeding is made to the Step S235.

In the Step S235, the “status 4” is acquired from the status transition table 430.

In the Step S236, the status subsequent to the “boot-up” is the “active status” from the status transition table 430, and it is the “status 4” at the time, accordingly the status is the same as that acquired in the Step S235, which means the normal transition status.

An explanation is further made regarding the other example in the case of a plurality of status existing.

In the Step S231, for example, the “stand-by” is acquired.

In the Step S232, the “status 2”, the “status 5”, and the “status 7” are acquired as the corresponding status at the time, from the status transition table 430.

In the Step S233, for example, if the “boot-up” is acquired, No is for the Step S234 and the proceeding is made to the Step S235.

In the Step S235, the “status 3” is acquired from the status transition table 430.

In the Step S236, the status subsequent to the “stand-by” is the “boot-up”, “power supply OFF” from the status transition table 430, and the “status 3”, “status 1” at the time, accordingly what is acquired in the step S235 is included, accordingly, it is the same as what is acquired in the Step S235, which means the normal transition status.

The monitoring server 300 (computer status monitoring device) of this embodiment stores the status transition table 430 (status transition information) which is the transition information of the status of the computer 500 in the power status database 400, and in the case that the transition status of the computer 500 based on the status acquired by the computer status detection unit 220 is out of the status transition of the status transition information, the computer status monitoring unit 230 can determine that the computer status is malfunction.

### A COMPUTER OPERATION STATUS DETECTION EXAMPLE

FIG. 13 is a flowchart showing the processing of the operation status detection unit 240. In the computer 500, in the active status of the processor (CPU (Central Processing Unit)), in general, the power consumption highly varies in a short time compared with other electric appliances. By utilizing this characteristic, an explanation is made with reference to FIG. 13, regarding the method to detect the operation status of the computer.

The operation status detection unit 240 acquires the change pattern of the power consumption of the computer within a certain time from the power consumption measuring device 100 via the data acquisition unit 205 (Step S241), and acquires the variation of the acquired change pattern (difference between the minimum value and the maximum value of the power consumption) (Step S242). The operation status detection unit 240 judges whether the variation is relatively flat (for example, within 5 W) or not (Step S243). If the variation is relatively flat (Step S243, Yes), the operation status detection unit 240 determines that the computer 500 is in an “inactive status” (Step S244), and proceeds to the Step S246. On the other hand, in the case that the variation of the change pattern is large (Step S243, No), the operation status detection unit 240 determines that the computer 500 is in an “active status” (Step S245), and proceeds to the Step S246.

The operation status detection unit 240 judges whether it is the same as the previous status or not (Step S246), proceeds back to the Step S241 in the case that it is the same as the previous status (Step S246, Yes), and in the case that it is different from the previous status (Step S246, No), notifies the management console 320 of the status of the computer 500 (Step S247), and terminates the processing.

Generally, in the case to monitor a utilization ratio history of the CPU of the computer 500, a mechanism for measuring the utilization ratio of the CPU in the interior of the correspondent computer 500 is essential, however in this embodiment, the operation status of the CPU is judged from the power consumption, accordingly the mechanism is not necessary to be embedded in the interior of the computer and the status can be detected even on the computer not having the mechanism for measuring the utilization ratio of the CPU.

In the case that the variation of the measurement data acquired by the data acquisition unit 205 moves in the predetermined values and doesn't vary, the operation status detection unit 240 of the monitoring server 300 of this embodiment can determine that the aforementioned computer is not operating.

By this embodiment, it becomes possible to detect the status of the computer 500 without installing the special management software to the computer 500. Since the management software generally becomes operable after the operating system is booted up, the management cannot be performed until the operating system completes the boot-up.

However, in this embodiment, it is possible to detect the status without using the management software, by using the power consumption value, and it becomes possible to manage the boot-up of the operating system. Moreover, in the case that the operating system is hung up, the management software cannot be either operated and the management cannot be performed, however, by utilizing the present invention, the management can be performed without depending on the status of the operating system.

Furthermore, it is possible to co-exist with the conventional management software. It is conceivable that the present invention is utilized for the purpose to detect the boot-up of the operating system or the malfunction, and the conventional management software performs the management after the operating system is operated. In this case, this embodiment can be realized by detecting the boot-up of the operating system, detecting the malfunction of the operating system only, and not detecting in the active status. And as another method, a method is conceivable to give an alert to the administrator when detecting the malfunction of the active status according to the present invention.

By the means to detect the status of the computer from the power consumption proposed by this embodiment, the following operation status of the computer can be grasped even if the monitoring program is not being executed on the computer.
(1) Grasping the operation status of the computer for all stages of before-the-boot-up to the-boot-up to the-stop.
(2) Detecting the malfunction termination status of the computer.

Moreover, by storing the change pattern of the power consumption in the case the computer is normally booted up and stops in the power status database, and comparing the change history of the power consumption of the computer and the change pattern in the power status database, the computer malfunction can be detected if both don't match.

Moreover, by utilizing the change patterns of the power consumption specific to the computer, the operation status of the processor (CPU) can be detected.

### EXPLANATION OF REFERENCES

100 power consumption measuring device
110 power supply
200 status detection program
205 data acquisition unit
210 computer status data generating unit
220 computer status detection unit
230 computer status monitoring unit
240 operation status detection unit
300 monitoring server (computer status monitoring device)
301 memory
302 processor (CPU)
310 storage
320 management console
400 power status database
410 waveform pattern table
420 waveform range table (waveform range information)
430 status transition table (status transition information)
500 computer

1. A computer status monitoring device for monitoring a status of a computer using measurement data of a power consumption measuring device to measure power consumption of the computer to be a monitored object, comprising:
a power status database for storing patterns of power consumption per status of the computer;
a data acquisition unit for acquiring measurement data of the power consumption measured by the power consumption measuring device; and
a computer status detection unit for judging which status pattern stored in the power status database a change pattern of the acquired measurement data is similar to or not and detecting a status corresponding to the pattern which has been judged to be similar as a computer status of the monitored object.

2. The computer status monitoring device according to claim 1, wherein the computer status includes at least status of deactivation of power supply, status of stand-by, status of boot-up of processor, and status of active status of the processor.

3. The computer status monitoring device according to claim 1, further comprising a computer status data generating unit for acquiring measurement data from activation of power supply of the computer to deactivation of the power supply of the computer from the data acquisition unit, receiving setting time of the computer status for storing patterns of power consumption per the status, sampling the measurement data based on the setting time, and storing the sampled measurement data being made correspondent to the computer status in the power status database.

4. The computer status monitoring device according to claim 1, further storing waveform range information of power consumption in which patterns of power consumption per status of the computer are made correspondent to a lower limit value and an upper limit value of power consumption of the computer in the power status database,
wherein the computer status detection unit acquires a minimum value and a maximum value of power consumption from change patterns of the acquired measurement data, judges which status pattern stored in the power status database a change pattern of the acquired measurement data is similar to on a basis of waveform range information of the power consumption, and detects a status corresponding to the pattern which has been judged to be similar as the computer status of the monitored object.

5. The computer status monitoring device according to claim 1, further
storing status transition information which is transition information of computer status in the power status database; and
comprising a computer status monitoring unit for determining that the computer status is malfunction in a case that transition status of the computer based on status acquired by the computer status detection unit is out of status transition of the status transition information.

6. The computer status monitoring device according to claim 1, further comprising a operation status detection unit for determining that the computer is not operating in a case that variation of measurement data acquired by the data acquisition unit moves in predetermined values and doesn't vary.

7. A computer monitoring system for monitoring the computer status by utilizing measurement data of the power consumption measuring device to measure power consumption of computer to be a monitored object, comprising:
a power status database for storing patterns of power consumption per status of the computer;
a data acquisition unit for acquiring measurement data of the power consumption measured by the power consumption measuring device; and
a computer status detection unit for judging which status pattern stored in the power status database a change pattern of the acquired measurement data is similar to or not and detecting status corresponding to pattern which has been judged to be similar as the status of computer of the monitored object.

8. The computer monitoring system according to claim 7, wherein status of the computer includes at least status of deactivation of power supply, status of stand-by, status of boot-up of processor, and status of active status of the processor.

9. The computer monitoring system according to claim 7, further comprising a computer status data generating unit for acquiring measurement data from activation of power supply of the computer to deactivation of the power supply of the computer from the data acquisition unit, receiving setting time of the computer status for storing patterns of power consumption per the status, sampling the measurement data on a basis of the setting time, and storing the sampled measurement data being made correspondent to the computer status in the power status database.

10. The computer monitoring system according to claim 7, further storing waveform range information of power consumption in which patterns of power consumption per status of the computer are made correspondent to the lower limit value and the upper limit value of power consumption of the computer in the power status database,
wherein the computer status detection unit acquires the minimum value and the maximum value of power consumption from change patterns of the acquired measurement data, judges which status pattern stored in the power status database a change pattern of the acquired measurement data is similar to on a basis of waveform range information of the power consumption, and detects a status corresponding to the pattern which has been judged to be similar as the computer status of the monitored object.

11. The computer monitoring system according to claim 7, further
storing status transition information which is transition information of computer status in the power status database; and
comprising a computer status monitoring unit for determining that the computer status is malfunction in a case that transition status of the computer based on status acquired by the computer status detection unit is out of status transition of the status transition information.

12. The computer monitoring system according to claim 7, further comprising a operation status detection unit for determining that the computer is not operating in a case that variation of measurement data acquired by the data acquisition unit moves in predetermined values and doesn't vary.

13. A computer status monitoring method of the computer status monitoring device for monitoring the computer status by utilizing measurement data of a power consumption measuring device to measure power consumption of computer to be a monitored object,
wherein the status monitoring device comprises:
a power status database for storing patterns of power consumption per the computer status;
a data acquisition unit for acquiring measurement data of the power consumption measured by the power consumption measuring device; and
a computer status detection unit for detecting computer status,
wherein the computer status detection unit judges which status pattern stored in the power status database a change pattern of the acquired measurement data is similar to or not and detects a status corresponding to the pattern which has been judged to be similar as the computer status of the monitored object.

14. The computer status monitoring method according to claim 13, wherein status of the computer includes at least status of deactivation of power supply, status of stand-by, status of boot-up of processor, and status of active status of the processor.

15. The computer status monitoring method according to claim 13, wherein the computer status monitoring device further comprises a computer status data generating unit and the computer status data generating unit
acquires the measurement data from activation of power supply of the computer to deactivation of power supply of the computer from the data acquisition unit;
receives setting time of status of the computer for storing patterns of power consumption per the status;
samples the measurement data on a basis of the setting time; and
stores the sampled measurement data being made correspondent to status of the computer.

16. The computer status monitoring method according to claim 13,
wherein the computer status monitoring device further stores waveform range information of power consumption in which patterns of power consumption per status of the computer are made correspondent to the lower limit value and the upper limit value of power consumption of the computer in the power status database,
wherein the computer status detection unit
acquires the minimum value and the maximum value of power consumption from change patterns of the acquired measurement data;
judges which status pattern stored in the power status database a change pattern of the acquired measurement data is similar to on a basis of waveform range information of the power consumption; and
detects a status corresponding to pattern which has been judged to be similar as the computer status of the monitored object.

17. The computer status monitoring method according to claim 13,
wherein the computer status monitoring device further comprises a computer status monitoring unit and stores status transition information which is transition information of computer status in the power status database,
wherein the computer status monitoring unit determines that the computer status is malfunction in a case that transition status of the computer based on status acquired by the computer status detection unit is out of status transition of the status transition information.

18. The computer status monitoring method according to claim 13,
wherein the computer status monitoring device further comprises a operation status detection unit,
wherein the operation status detection unit determines that the computer is not operating in a case that variation of measurement data acquired by the data acquisition unit moves in predetermined values and doesn't vary.
